(19) United States
(12) Patent Application Publication
(10) Pub. No.: US 2017/0050296 A1
(43) Pub. Date: Feb. 23, 2017

(54) Driving device for open-end wrench

(71) Applicant: TZU-CHUN CHEN, Taichung City (TW)

(72) Inventor: TZU-CHUN CHEN, Taichung City (TW)

(21) Appl. No.: 14/827,353

(22) Filed: Aug. 17, 2015

(51) Int. Cl. B25B 13/08; B25B 13/46

(52) U.S. Cl. CPC B25B 13/08; B25B 13/46

(57) ABSTRACT

A driving device for an open-end wrench contains: a body including an operating handle, a driving head, and a rotatable clamping portion. The rotatable clamping portion has a first jaw, a second jaw, and a V-shaped abutting fence defined on a rear end of the rotatable clamping portion. A first inner face of the first jaw has a first of two recessed areas adjacent to a top of the first jaw, and between the first inner face of the first jaw and the V-shaped abutting fence is defined a second of the two recessed areas. Between the first recessed area and the second recessed area is formed an arcuately convex area. Between a second inner face on a front end of an inner wall of the second jaw and a contacting face on a rear end of the inner wall of the second jaw is arranged an arcuately concave area.

### FIELD OF THE INVENTION

The present invention relates to a driving device for an open-end wrench which idly rotates a rotatable clamping portion by ways of a first jaw and a second jaw.

### BACKGROUND OF THE INVENTION

A conventional open-end wrench is applied to lock or unlock a hex nut and contains a rotating head with two clamp jaws, such that the two clamp jaws clamp the hex nut, and the hex nut is rotated by the rotating head which is driven by an operating handle to revolve.

However, an idle rotation is troublesome because a user has to rotate the open-end wrench from a start position to a stop position repeatedly.

The present invention has arisen to mitigate and/or obviate the afore-described disadvantages.

### SUMMARY OF THE INVENTION

The primary objective of the present invention is to provide a driving device for an open-end wrench which idly rotates a rotatable clamping portion by ways of a first jaw and a second jaw.

Another objective of the present invention is to provide a driving device for an open-end wrench in which the second jaw has a block fixed thereon, wherein as the rotatable clamping portion is rotated counterclockwise, the block moves inwardly and outwardly by matching with a workpiece to clamp the workpiece securely.

### BRIEF DESCRIPTION OF THE DRAWINGS

FIG. 1 is a perspective view showing the assembly of a driving device for an open-end wrench according to a first embodiment of the present invention.

FIGS. 2 to 7 are a plan side view showing the operation of the driving device for the open-end wrench according to the first embodiment of the present invention.

FIG. 8 is a perspective view showing the assembly of a driving device for an open-end wrench according to a second embodiment of the present invention.

FIG. 9 is another perspective view showing the assembly of the driving device for the open-end wrench according to the second embodiment of the present invention.

FIG. 10 is a perspective view showing the exploded components of the driving device for the open-end wrench according to the second embodiment of the present invention.

FIG. 11 is a cross sectional view showing the operation of the driving device for the open-end wrench according to the second embodiment of the present invention.

FIG. 12 is a cross sectional view taken along the line A-A of FIG. 11.

FIGS. 13 to 17 are a plan side view showing the operation of the driving device for the open-end wrench according to the second embodiment of the present invention.

FIG. 18 is a cross sectional view showing the application of two extensions of the driving device for the open-end wrench according to the second embodiment of the present invention.

### DETAILED DESCRIPTION OF THE PREFERRED EMBODIMENTS

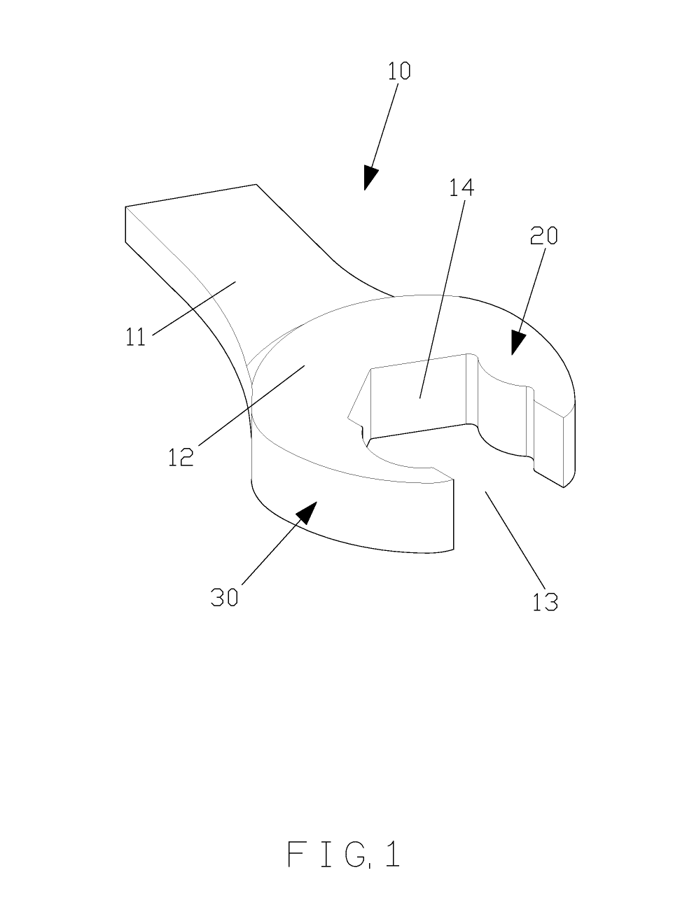

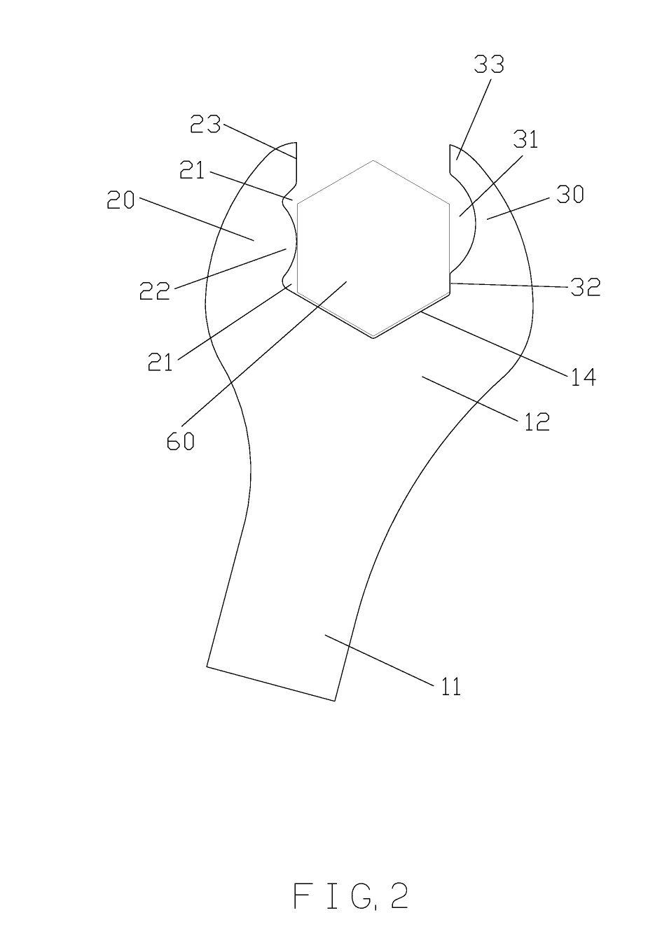

With reference to FIGS. 1 and 2, a driving device for an open-end wrench according to a first embodiment of the present invention comprises: a body 10, and the body 10 includes an operating handle 11, a driving head 12 formed on a front end of the operating handle 11, and a rotatable clamping portion 13 defined on the driving head 12 to fit with a workpiece, such as a hex nut, wherein the rotatable clamping portion 13 has a first jaw 20, a second jaw 30 opposite to the first jaw 20, and a V-shaped abutting fence 14 defined on a rear end of the rotatable clamping portion 13; wherein a first inner face 23 of the first jaw 20 has a first of two recessed areas 21 adjacent to a top of the first jaw 20, and between a rear end of the first inner face 23 of the first jaw 20 and the V-shaped abutting fence 14 is defined a second of the two recessed areas 21, such that between the first recessed area 21 and the second recessed area 21 is formed an arcuately convex area 22, and between a second inner face 33 on a front end of an inner wall of the second jaw 30 and a contacting face 32 on a rear end of the inner wall of the second jaw 30 is arranged an arcuately concave area 31.

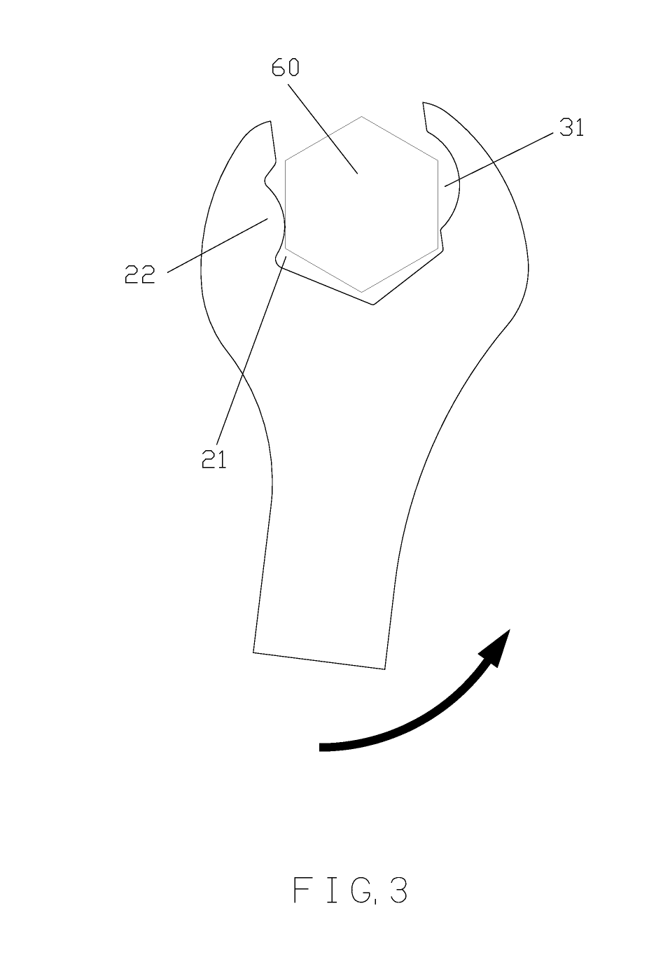

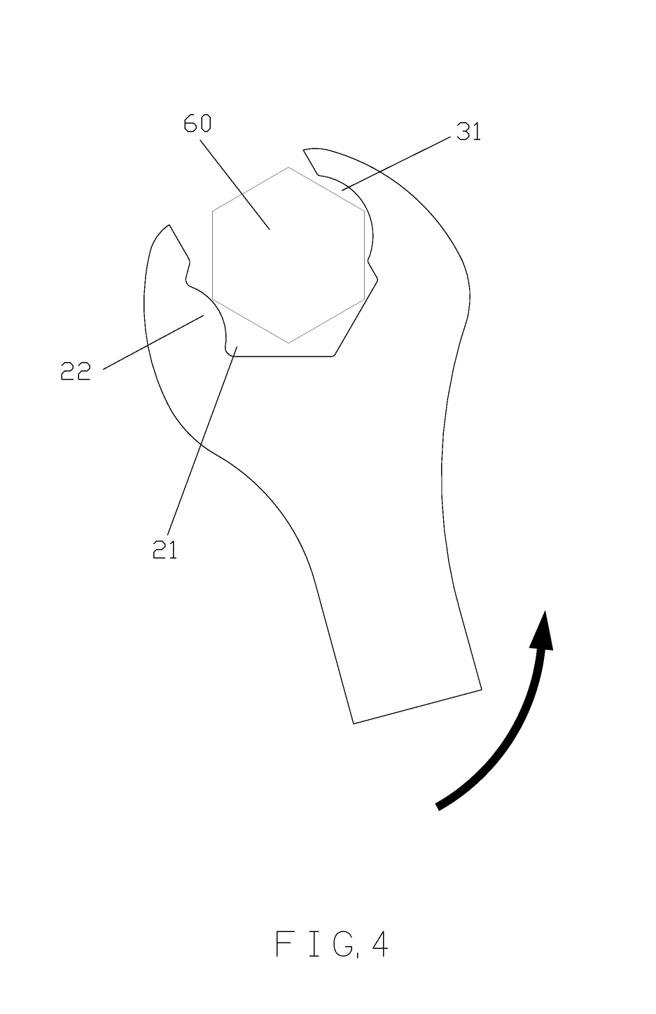

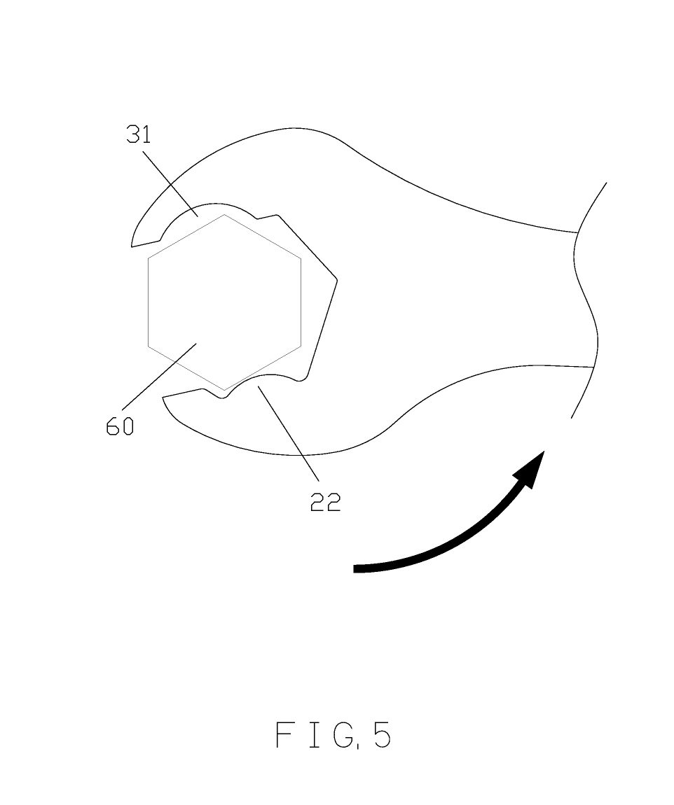

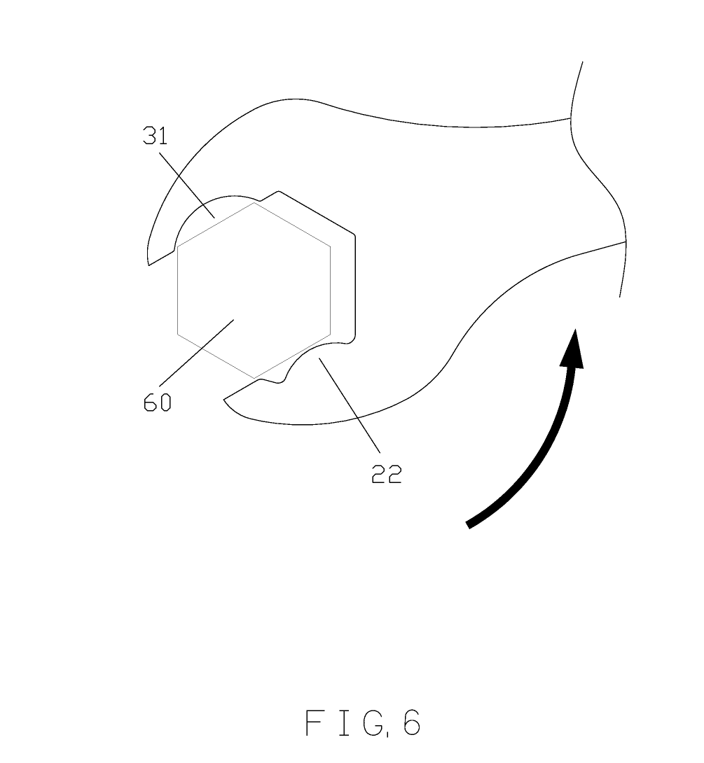

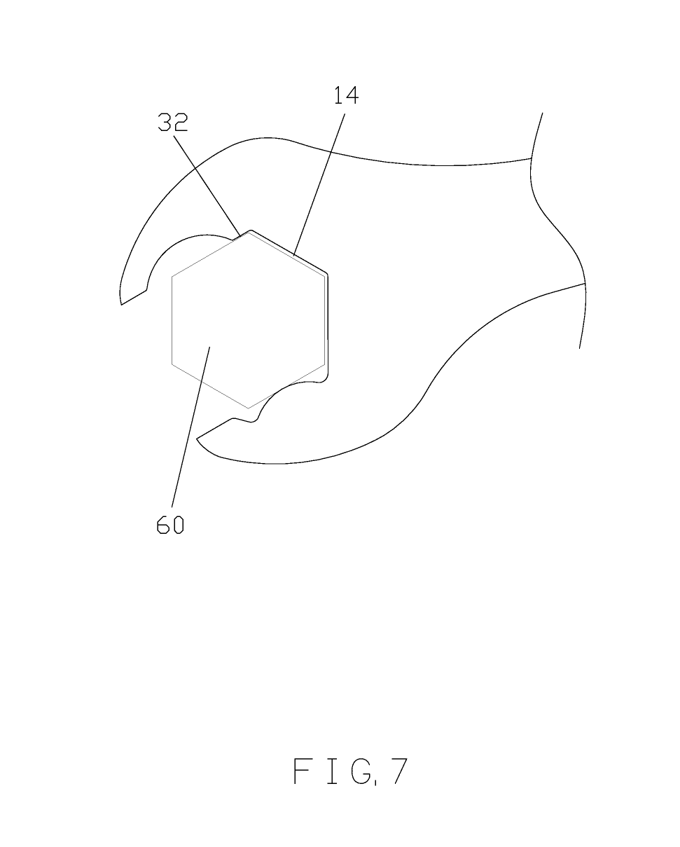

Referring to FIGS. 2 to 7, as desiring to rotate the operating handle 13 clockwise, a workpiece 60 contacts with the V-shaped abutting fence 14 and the contacting face 32, and the workpiece 60 is driven by rotating the operating handle 13 to revolve. Thereafter, the operating handle 13 is rotated counterclockwise so that a first of six corners of the workpiece 60 moves into the second recessed area 21, and the arcuately concave area 31 of the second jaw 30 moves across a second of the six corners of the workpiece 60 opposite to the first corner of the workpiece 60. After rotating the operating handle 11 continuously, the first corner of the workpiece 60 is retained by the arcuately convex area 22 and moves into the first second recessed area 21 from the second recessed area 21 via a top of the arcuately convex area 22, hence the second corner of the workpiece 60 moves away from the arcuately concave area 31 to rotate the body 10 idly. Thereafter, the workpiece 60 is retained by the V-shaped abutting fence 14 and the contacting face 32 to rotate the workpiece 60 again, thus rotating the workpiece 60 easily in a limited operating space.

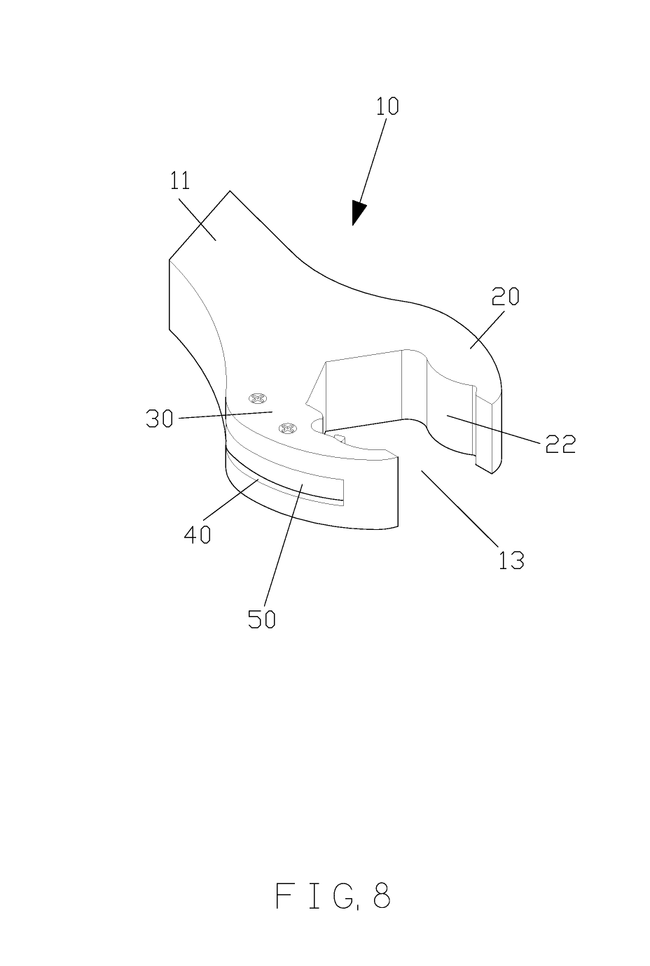

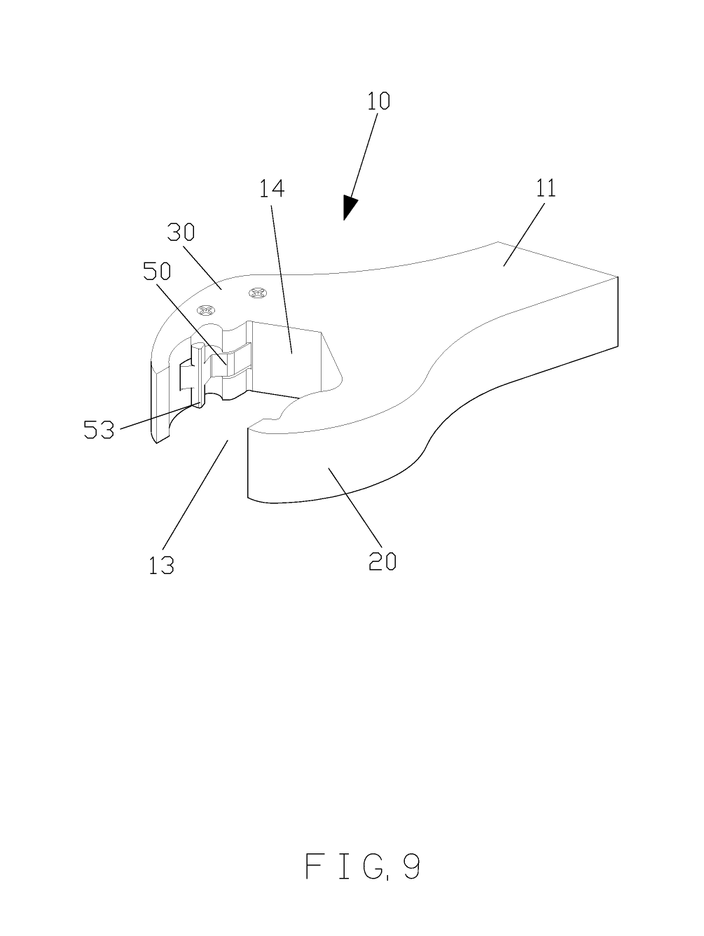

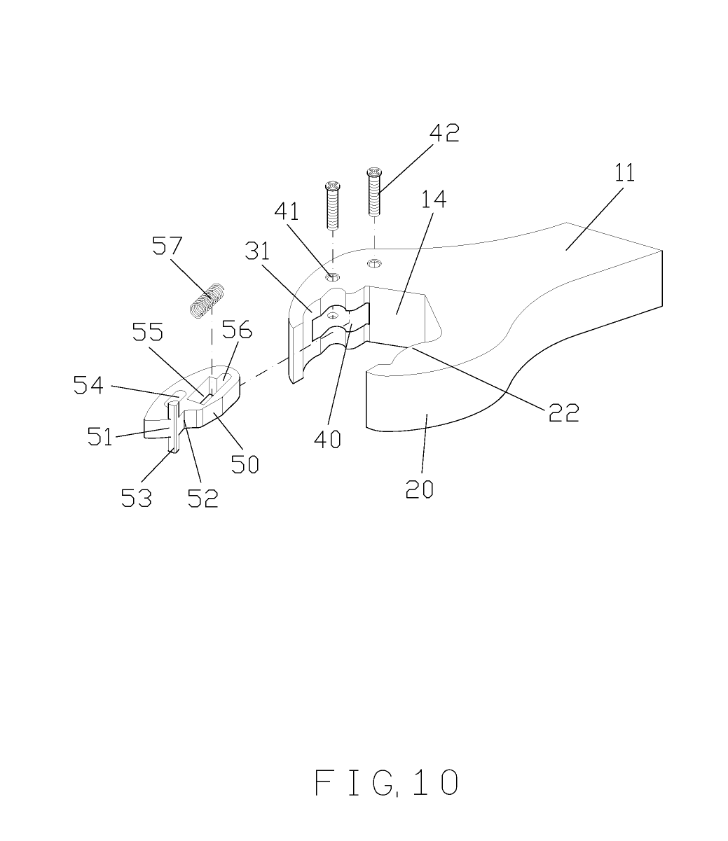

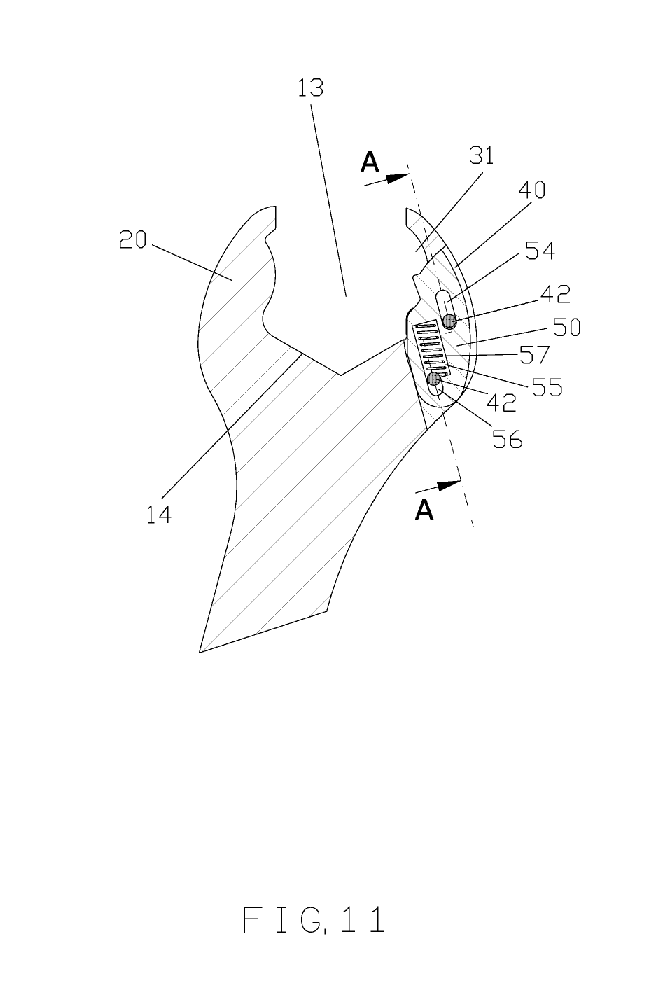

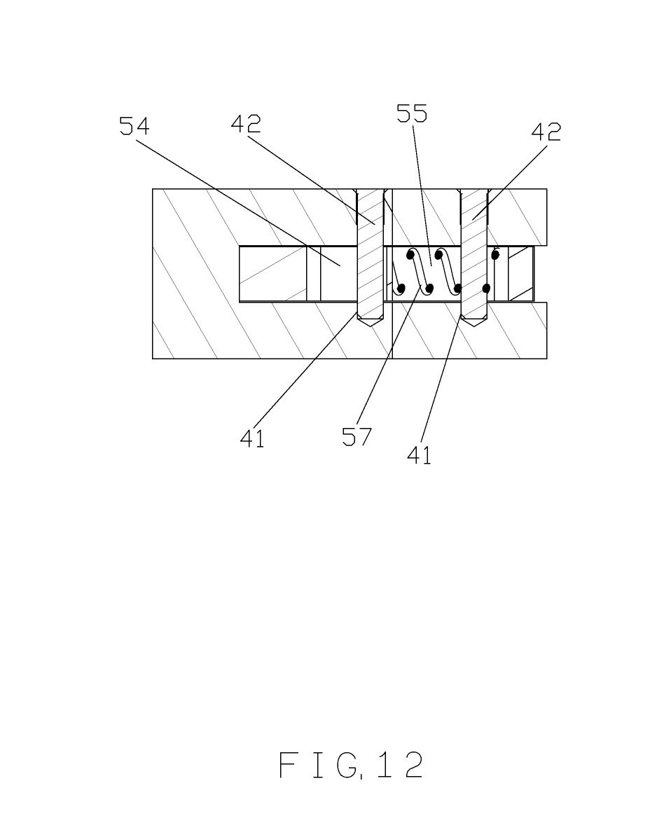

As shown in FIGS. 8 to 12, in a second embodiment, the second jaw 30 has a slot 40 defined on an outer wall thereof to accommodate a block 50, wherein the block 50 has a pushing face 51 defined on a front end of an inner wall thereof, a V-shaped face 52 formed on the inner wall thereof behind the pushing facing 51, two extensions 53 extending outwardly from a connection of the pushing facing 51 and the V-shaped face 52, a first notch 54 defined thereon, a second notch 55 arranged thereon, a cutout 56 extending from a rear end of the second notch 55, and an elastic element 57 fixed in the second notch 55. The second jaw 30 has two locking orifices 41 defined thereon corresponding to the first notch 54 and the cutout 56 of the block 50, such that when the block 50 is fixed in the slot 40, two fixing bolts 42 are locked in the two locking orifices 41 to limit the first notch 54 and the cutout 56.

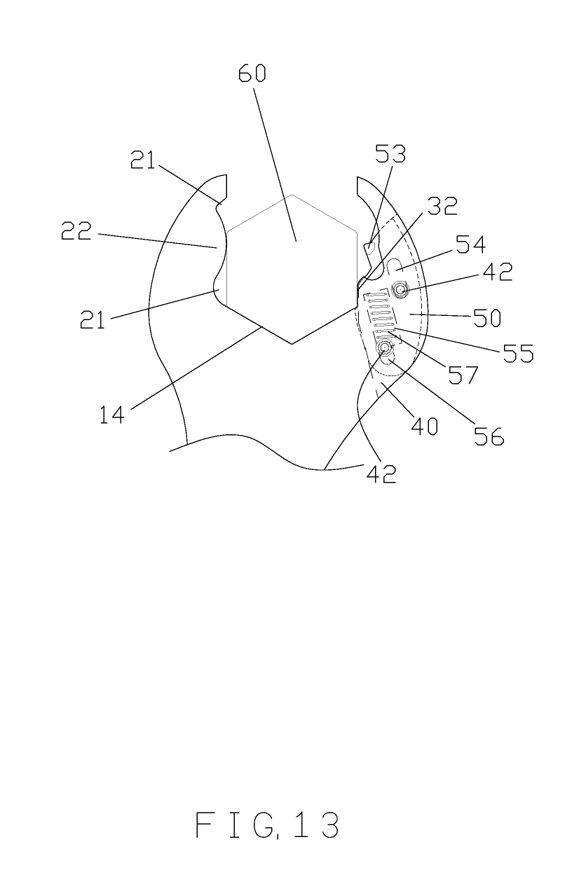

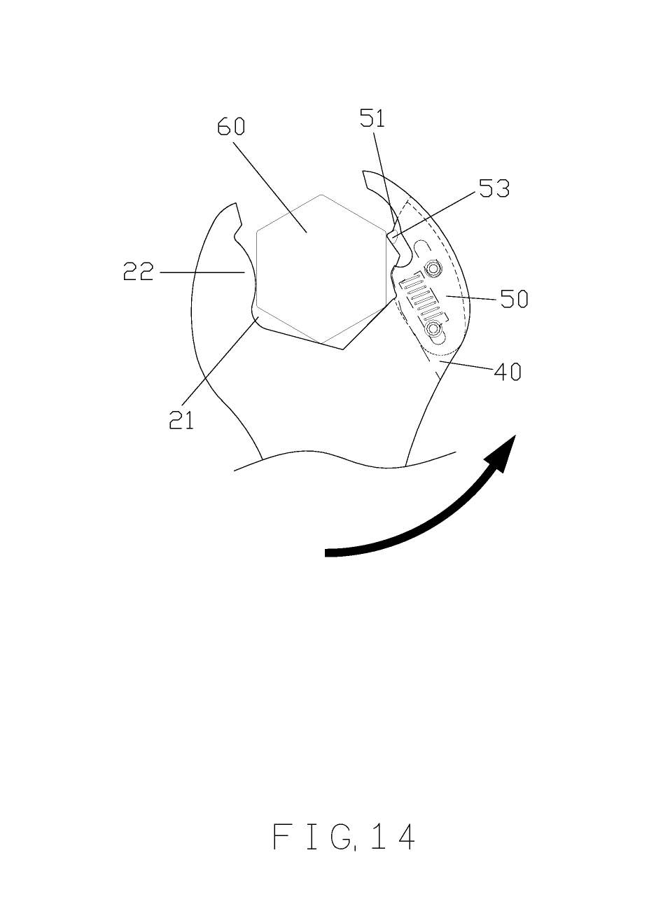

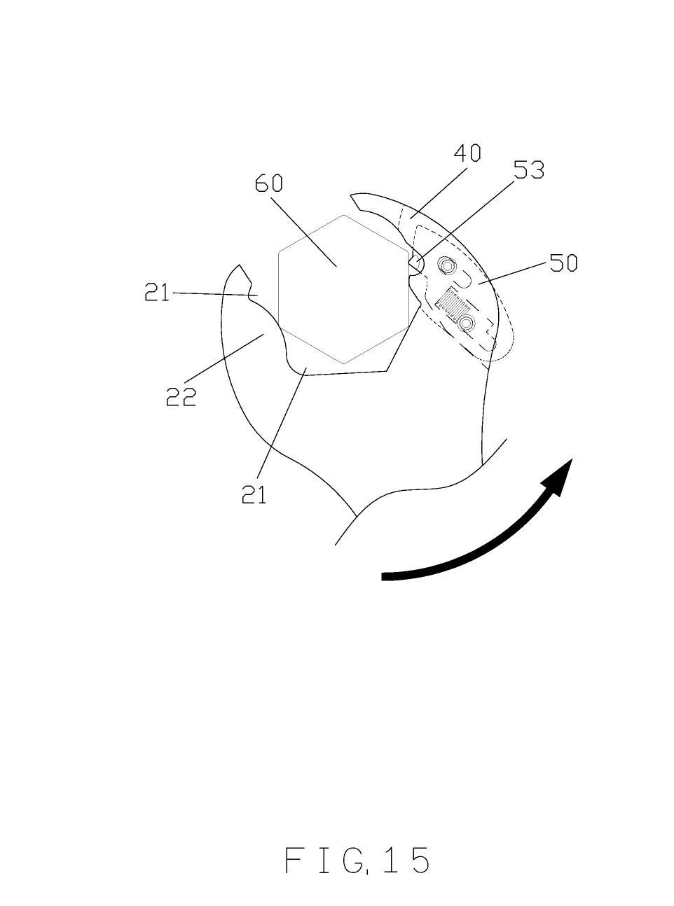

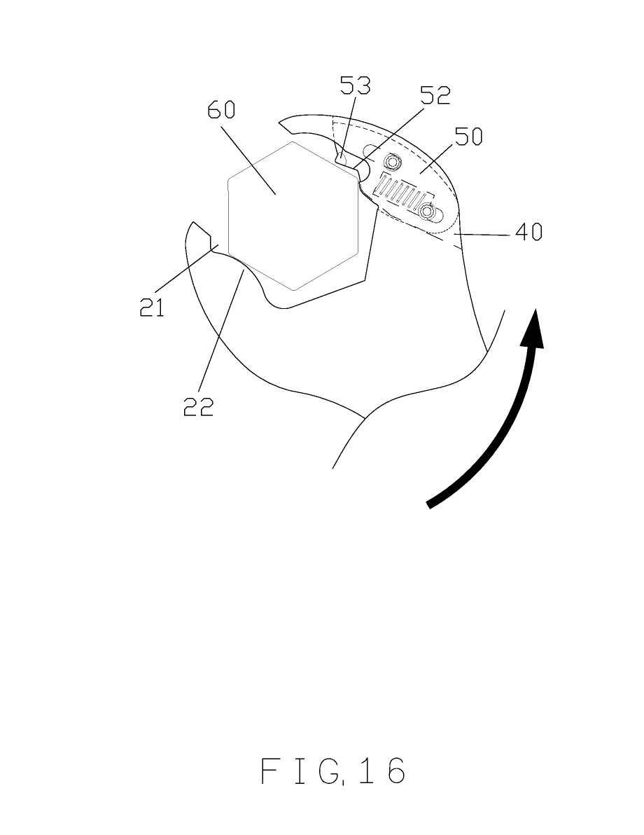

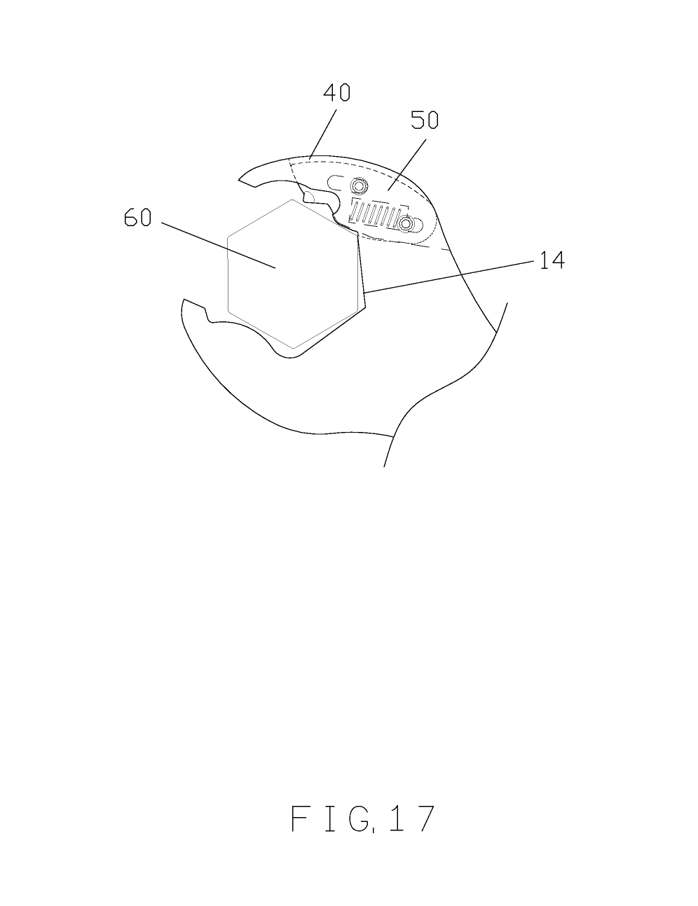

As illustrated in FIGS. 13 to 17, the block 50 is pressed to move in the slot 40 by using the first notch 54 and the cutout 56, and the elastic element 57 is pressed by the block 50 in the second notch 55. When the block 50 is released, the elastic element 57 returns back to its original position, such that when the rotatable clamping portion 13 is driven by rotating the operating handle 11 counterclockwise to revolve, the first corner of the workpiece 60 moves into the second recessed area 21, and the second corner of the workpiece 60 opposite to the first corner of the workpiece 60 pushes the pushing face 51 of the block 50. After continuously rotating the body 10 counterclockwise, the first corner of the workpiece 60 moves into the first recessed area 21 from the second recessed area 21 via the top of the arcuately convex area 22, and the second corner of the workpiece 60 moves into the V-shaped face 52 from the pushing face 51, thus moving the block 50 back to an original position. Accordingly, the block 50 enhances an engagement of the workpiece 60.

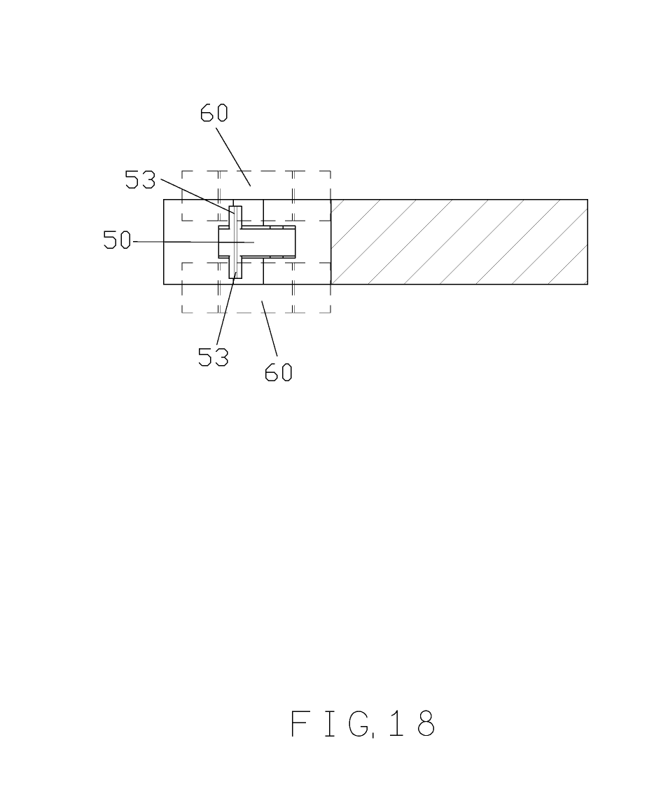

With reference to FIG. 18, the two extensions 53 enhance a contacting area of the block 50 and the workpiece 60.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A driving device for an open-end wrench comprising: a body, and the body including an operating handle, a driving head formed on a front end of the operating handle, and a rotatable clamping portion defined on the driving head to fit with a workpiece; wherein
the rotatable clamping portion has a first jaw, a second jaw opposite to the first jaw, and a V-shaped abutting fence defined on a rear end of the rotatable clamping portion;
a first inner face of the first jaw has a first of two recessed areas adjacent to a top of the first jaw, and between a rear end of the first inner face of the first jaw and the V-shaped abutting fence is defined a second of the two recessed areas, between the first recessed area and the second recessed area is formed an arcuately convex area;
between a second inner face on a front end of an inner wall of the second jaw and a contacting face on a rear end of the inner wall of the second jaw is arranged an arcuately concave area;
the rotatable clamping portion is idly rotated counterclockwise by ways of the first jaw and the second jaw.

2. The driving device for the open-end wrench as claimed in claim 1, wherein when the operating handle rotates clockwise, the workpiece contacts with the V-shaped abutting fence and the contacting face.

3. The driving device for the open-end wrench as claimed in claim 1, wherein the operating handle is rotated counterclockwise so that a first of six corners of the workpiece moves into the second recessed area, and the arcuately concave area of the second jaw moves across a second of the six corners of the workpiece opposite to the first corner of the workpiece, and after rotating the operating handle continuously, the first corner of the workpiece is retained by the arcuately convex area and moves into the first second recessed area from the second recessed area via a top of the arcuately convex area, hence the second corner of the workpiece moves away from the arcuately concave area to rotate the body idly.

4. The driving device for the open-end wrench as claimed in claim 1, wherein the first corner of the workpiece is retained by the arcuately convex area after moves away from the second recessed area.

5. A driving device for an open-end wrench comprising: a body, and the body including an operating handle, a driving head formed on a front end of the operating handle, and a rotatable clamping portion defined on the driving head to fit with a workpiece; wherein
the rotatable clamping portion has a first jaw, a second jaw opposite to the first jaw, and a V-shaped abutting fence defined on a rear end of the rotatable clamping portion;
a first inner face of the first jaw has a first of two recessed areas adjacent to a top of the first jaw, and between a rear end of the first inner face of the first jaw and the V-shaped abutting fence is defined a second of the two recessed areas, between the first recessed area and the second recessed area is formed an arcuately convex area;
between a second inner face on a front end of an inner wall of the second jaw and a contacting face on a rear end of the inner wall of the second jaw is arranged an arcuately concave area;
the second jaw has a slot defined on an outer wall thereof to accommodate a block, and the block has a pushing face defined on a front end of an inner wall thereof, a V-shaped face formed on the inner wall thereof behind the pushing facing, two extensions extending outwardly from a connection of the pushing facing and the V-shaped face, a first notch defined thereon, a second notch arranged thereon, a cutout extending from a rear end of the second notch, and an elastic element fixed in the second notch;
the second jaw has two locking orifices defined thereon corresponding to the first notch and the cutout of the block, such that when the block is fixed in the slot, two fixing bolts are locked in the two locking orifices to limit the first notch and the cutout.

6. The driving device for the open-end wrench as claimed in claim 5, wherein the block is pressed to move in the slot by using the first notch and the cutout, and the elastic element is pressed by the block in the second notch, and when the block is released, the elastic element returns back to its original position.

7. The driving device for the open-end wrench as claimed in claim 5, wherein when the rotatable clamping portion is driven by rotating the operating handle counterclockwise to revolve, the first corner of the workpiece moves into the second recessed area, and the second corner of the workpiece opposite to the first corner of the workpiece pushes the pushing face of the block; after continuously rotating the body counterclockwise, the first corner of the workpiece moves into the first recessed area from the second recessed area via the top of the arcuately convex area, and the second corner of the workpiece moves into the V-shaped face from the pushing face, thus moving the block back to an original position.

8. The driving device for the open-end wrench as claimed in claim 5, wherein the two extensions enhance a contacting area of the block and the workpiece.
